(19) United States
(12) Patent Application Publication
(10) Pub. No.: US 2019/0314763 A1
(43) Pub. Date: Oct. 17, 2019

(54) Autonomous Wave Powered Desalination

(71) Applicant: Alexander Klebnikov, Houston, TX (US)

(72) Inventors: Alexander Klebnikov, Houston, TX (US); Christina Springer, Saugus, CA (US); William Cheng, Palo Alto, CA (US); Chevonae Walcott, Milton (CA)

(73) Assignee: Alexander Klebnikov, Houston, TX (US)

(21) Appl. No.: 15/955,684

(22) Filed: Apr. 17, 2018

(51) Int. Cl. B01D 61/02; B01D 61/10; C02F 1/44

(52) U.S. Cl. CPC B01D 61/025; B01D 61/022; C02F 2103/08; C02F 1/441; B01D 61/10

(57) ABSTRACT

A wave powered water desalinating device may receive untreated salt water, and produce desalinated fresh water. The device consists of a pressure chamber, with a piston coupled with a pitching-type wave energy converter and configured to move along the major axis of the compression chamber; an inlet one-way valve configured to permit flow into the compression chamber from the exterior; a spring in fluid communication with the piston configured to absorb and control the cyclic pressure of the system; and a reverse osmosis membrane in the interior of the compression chamber such that motion of the piston in the direction of the distal end of the chamber exerts contents of the interior of the chamber against the reverse osmosis membrane producing fresh water.

### TECHNICAL FIELD

The present disclosure relates to devices and methods of desalinating water with the use of reverse osmosis filtration.

More particularly, this invention relates to novel methods of modulating pressure generated by wave energy convertors to reduce the degradation of reverse osmosis systems, and significantly increase output of potable water.

### BACKGROUND

Currently, more than one billion people lack access to clean drinking water. This number has steadily risen over recent decades and is predicted to become more severe in the future. Many of those who lack access to potable water live in remote areas or underdeveloped areas and are thus susceptible to severe health risks as a result of water scarcity. Approximately 40% of severely water stressed areas are within 50 miles of an ocean coast.

One way to address this water crisis is to utilize reverse osmosis technology. Reverse osmosis is a process that can extract clean water from salt water by forcing the salt water through a thin, permeable membrane. Salt molecules are too large to fit through the small pores of the membrane, so pure fresh water can be collected from this process.

Most reverse osmosis solutions that are implemented today, however, are done on an industrial scale. They are large plants that contain hundreds of reverse osmosis membranes and require large amounts of electricity, typically powered by the burning of fossil fuels, to provide them with the amount of energy they need. This type of solution is not attainable for all geographical areas, as remote locations often do not have the well-established electricity grid infrastructure necessary to support reverse osmosis on an industrial scale. Accordingly, there is a long-felt need in the field for reverse osmosis desalination technologies that are not reliant on electricity or other energy sources that are not always accessible in remote or developing locations.

There are two main types of desalination that are utilized in industry today: thermal desalination and reverse osmosis desalination. The thermal desalination process uses energy to evaporate water and subsequently condense it again. This occurs when there is waste heat from an existing process, sufficient electricity available, or a specific heat generating energy source available. Reverse Osmosis (RO) desalination uses the principle of artificial diffusion to remove salt and other impurities, by transferring water through a series of semi-permeable membranes. Thermal desalination uses a source of heat to change saline water into vapor. This vapor, or steam, is generally free of the salt, minerals, and other contaminants that were in the saline water. Therefore, when condensed, this vapor forms a high-purity distilled water. The debated advantage for thermal desalination is that, unlike RO desalination, it doesn't use a prime source of energy that could otherwise be used elsewhere. However, in water stressed areas, there is often not a well-developed infrastructure to provide these “prime sources of energy” in the first place. For example, these areas will likely not have waste heat from existing processes that can be used to drive thermal desalination.

The membrane is the key mechanism that facilitates any reverse osmosis effort. In a hypothetical RO setup, a compartment housing saltwater (or any other mineralized water) is separated from a second compartment containing freshwater by a semipermeable membrane. That membrane acts as a filter that allows for water molecules to pass through but bars the passage of mineral molecules, which are too large to fit through the pores of the membrane. The natural movement of water through a membrane is driven by naturally occurring osmosis, which is the tendency for freshwater molecules to move from the side with low salinity to that of high salinity until salinity concentration equilibrium is achieved on both sides. The pressure enacted by the transporting of freshwater molecules is known as ‘osmotic pressure’. Reverse osmosis on the other hand attempts to reverse the naturally occurring phenomenon described above by exerting an external pressure that counteracts osmosis. The high-salinity water content is subjected to a high pressure, overriding the osmotic pressure and driving additional freshwater wined as permeate from the region of high salinity to low salinity. But, typical RO desalination also requires the use of an established electricity grid as with current plant set ups. The startup cost for a plant is on the order of hundreds of millions of dollars, which places a heavy burden on developing nations and even threatens to stunt their growth.

Wave Energy Converters: To provide remote areas with the energy they need to drive reverse osmosis desalination, one may harness energy from ocean waves through the implementation of a wave energy converter, also known generally as a WEC.

There are existing solutions by which energy is captured from the ocean waves and utilized to generate electricity for human use.

Surface attenuator wave energy conversion systems float at the surface of the water. Pelamis, an industrially implemented device is made up of large cylindrical sections connected by hinged joints. As waves move the links up and down, they rotate about their hinged joints. This motion activates hydraulic cylinders that then drive a motor and generator which are contained inside each link. An underwater cable then carries the generated electricity back to shore and to the grid. Another type of surface attenuator device consists of rectangular rafts rather than cylindrical links, but the principles by which the device operates are the same.

Another common type of WEC is an overtopping device. Overtopping devices are usually simple in design, which makes their analysis and upkeep simple as well. An overtopping device includes an inclined funnel-shaped structure that pushes waves uphill. It does so by increasing the wave's kinetic energy (as cross-sectional area decreases) and converting it to potential energy. Once the water has climbed uphill in this manner, it enters a reservoir. From that point, its gravitational potential can then be utilized for productive work. Typically, the water may drop back downhill through a pipe that contains a turbine. The power output from this type of system is dependent upon the height to which the water is raised and the properties of the turbine.

Heaving Body and Pitching Body WECs take advantage of a wave's chaotic, transient shapes. By assuming a sinusoidal wave profile, one can develop WECs based on pure heaving and pure pitching motion. These types of motion are relatively simple to imagine and to analyze.

A Heaving Body is constrained in the direction of movement of the waves so that its motion is purely vertical. The device moves with respect to the ocean floor as a result of the peaks and troughs contained in the sinusoidal wave profile. For maximum power output from this type of wave energy converter, a designer should try to match the natural frequency of the heaving body to that of the ocean waves so that the body will be allowed to resonate.

A different type of motion that may result from subjection to the ocean's waves is pitching, or pure rotation of a body about its center of gravity. A schematic of a pitching WEC is shown in FIG. 1. The efficiency of this device depends on the horizontal component of the velocity (surge component). Such a horizontal component is more prominent in regions of shallow water near the coast, where the surge component of the wave dominates the wave's energy profile. These heavy surges may provide enough force to drive the high pressures needed for reverse osmosis. The variety of WECs that utilize a ‘flange’ to harness the pitching or surging aspect of waves are typically known as Oscillating Surge Wave Energy Convertors (OSWEC).

FIG. 1—Oscillating Surge Wave Energy Convertor

Wave-Powered Desalination: The classical system uses a mechanical system to convert wave energy into mechanical energy, typically water pressure. One commonly considered system is described in FIG. 2, where the wave energy converter drives water through a liquid turbine/generator. This then either provides electricity directly to an end user, or in the case of desalination, powers a pump (often with an intermediary battery bank/regulator), that pushes water through a reverse osmosis system.

FIG. 2—Common application of WEC and desalination systems

### SUMMARY

Simply pairing a WEC with reverse osmosis (RO) desalination presents challenges not previously met in the art. If an RO membrane were directly attached to WEC, the membrane would experience cyclic, rapid pressure variations due to the periodic motion (driven by the wave frequency) of the WEC. However, the industry standard for RO membranes is that they are to be exposed to only very small pressure fluctuations, or else they may experience fatigue over time and be subject to damage. The presently disclosed technology modulates the fluctuating pressure profiles created by ocean waves to allow the direct integration of WECs with RO desalination.

Disclosed are pressure vessels that, in some embodiments, use a spring to mechanically capture and modulate the rapidly varying pressure of ocean waves. Such a vessel may contain one or more check valves that allow the system to push seawater through a reverse osmosis membrane at a nearly constant pressure. At the end of each wave cycle, it allows new salt water into the system to replace that which has been lost. A spring suitably synchronizes with the system as well as captures the proper amount of energy to maintain low pressure fluctuations on the reverse osmosis membrane, preventing possible damage. Testing on one embodiment showed that the disclosed technology could take feed water that has been laced with salt, dye, or other particulates (up to 1700 ppm) and reduce that particulate content down to 350 ppm, better than medical grade quality water.

When an incident wave hits an Oscillating Surge Wave Energy Convertor, it forces the WEC's vertical flange to pivot, due to both the weight of the wave itself, as well as the kinetic energy of the wave. The downward motion of the flange drives the piston forward, causing the pressure in the system to increase. This pressure causes fresh water to pass through a reverse osmosis membrane, leaving salt particles behind in the brine solution.

As the flange bends more, the area incident to the wave decreases, so the torque exerted on the WEC decreases, thus lowering the pressure experienced by the energy absorbing device (either a generator, liquid filled pipe or reverse osmosis system). At this point the pressure is lower than its peak, but still positive, so fresh water is still being produced but at a lower rate.

However, after the wave passes, the natural buoyancy of the WEC causes it to return back to its resting state. This means the piston driving the system will retract, pulling fresh water back through the reverse osmosis membrane, losing valuable product. The gauge pressure will be negative, and the RO membrane will go from experiencing a very high force in the axial direction to either no force, or even a force in the inverse direction. When any material, especially thin polymers experiences such a highly variable pressure, one typically observes fatigue damage.

The next wave cycle will cause the pressure to spike up again, and then after the wave passes, the pressure falls back to zero. This cycle will repeat every 8-14 seconds for the entire lifetime of the device (see FIG. 3).

Although one might pressurize water with a WEC and have that water push against a reverse osmosis membrane, RO membranes are extremely thin, and their porosity can be easily damaged by large pressure fluctuations, which would be deleterious to any wave powered system.

FIG. 3—Pressure on WEC and Membrane with wave passage

When considering the operational lifetime of a desalination system, the membrane is an important component. There are a number of processes that contribute to membrane damage: fouling accumulation, film oxidation, pressure differential increase, and backpressure. These processes can be sorted into two categories: mechanical damage and chemical damage. Any process that causes the membrane's polymeric fibers to degrade at the micro- or macro-level may be considered mechanical damage, whereas any external agent that changes the composition of the membrane will be labeled as chemical damage.

To ensure that this novel system's pressure fluctuations would not damage the membrane, one may perform Scanning Electron Microscopy as well as methyl blue porosity testing on samples of membranes that have undergone hundreds or thousands of simulated wave cycles. In this case, these samples were compared against control samples, and no damage was visible. There was also no observable degradation in performance on pressure tests, showing that the disclosed technology may be integrated with commercially available RO membranes.

### SUMMARY OF DISCLOSED TECHNOLOGY

The present disclosure provides, e.g., desalinating devices, which devices may include a compression chamber having an interior and being configured to receive minimally treated water, the compression chamber having an inlet, a proximal end, a distal end, and a major axis extending longitudinally from the proximal end to the distal end; an inlet one-way valve sealably engaged with the inlet, the inlet one-way valve being configured to permit flow into the compression chamber from exterior to the compression chamber; a piston operatively coupled to a wing, the piston being sealably disposed within the compression chamber, and, the piston being configured to move along the major axis of the compression chamber in the direction of the distal end of the chamber in response to the movement of the wing; a reverse osmosis membrane being in fluid communication with the interior of the compression chamber such that motion of the piston in the direction of the distal end of the compression chamber exerts contents of the interior of the compression chamber against the reverse osmosis membrane; and a spring member in fluid communication with the interior of the compression chamber, the spring member being configured to compress when the piston moves in the direction of the distal end of the compression chamber.

The desalinating device may include a check valve disposed within the compression chamber, the check valve being disposed between a first portion of the compression chamber and a second portion of the compression chamber, the check valve being disposed between the piston and the spring member, and the check valve being configured to permit flow in the direction of the spring member and resist flow away from the spring member. The spring member, when decompressing and when the check valve is closed, may be configured to exert contents of the compression chamber against the reverse osmosis membrane.

The reverse osmosis membrane may be a flatsheet membrane having a polyester fabric layer, a microporous polysulfone layer, and a barrier layer. The inlet one-way valve may be configured to allow the untreated water to pass in one direction through the valve into the compression chamber when the pressure inside the compression chamber is lower than the pressure outside the compression chamber, and to prevent the untreated water from passing in the opposite direction through the valve out of the compression chamber.

The spring member may have a spring stiffness in the range of from about 10 N/mm to about 500 N/mm, typically between 17.7 N/mm to about 150 N/mm.

The desalination device may include a controller positioned between the wing and the piston, the controller having an adjustable gear set configured to regulate the velocity and axial displacement of piston movement. In some embodiments, the wing may include a lighter-than-water buoy portion attached to the wing. In another embodiment, the wing may have an air receiving portion that is configured to receive air caused by motion of the water source and to use the received air to propel the piston.

In some embodiments, the spring member may be positioned between the proximal end and the distal end of the compression chamber. The reverse osmosis membrane may be positioned between the proximal end and the distal end of the compression chamber.

In some embodiments, the desalination device may have a plurality of wings and compression chambers, wherein the plurality of wings and compression chambers are in fluid communication with the same reverse osmosis membrane. An embodiment may also include a plurality of spring members. The plurality of spring members may be positioned in series relative to one another. In some embodiments, the plurality of spring members may be positioned in a parallel arrangement relative to one another, either alternatively or in combination with another embodiment.

In some embodiments, the spring member may include a spring actuator configured to engage and disengage the spring member in response to a command. The command to engage or disengage may come from a sensor connected to the device through wires or wirelessly.

In some embodiments, the desalination device may include a plurality of reverse osmosis membranes, wherein the plurality of reverse osmosis membranes is in fluid communication with the same compression chamber.

The desalination device may be configured to, during operation, permit pressure fluctuation on the reverse osmosis membrane of up to 60%, up to 50%, up to 40%, up to 30%, or up to 20%. In some embodiments, the desalination device may have a spring chamber having an interior that is in fluid communication with the interior of the compression chamber, wherein at least a portion of the spring member is disposed within the spring chamber. In further embodiments, the device may include a set of pistons—a first piston and a second piston—each of the first and second pistons being operatively connected to the wing such that movement of the wing in a first direction causes the first piston to move along the major axis toward the reverse osmosis membrane, and where movement of the wing in a second direction opposite the first direction causes the second piston to move along the major axis toward the reverse osmosis membrane.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a basic variant of an Oscillating Surge Wave Energy Convertor;

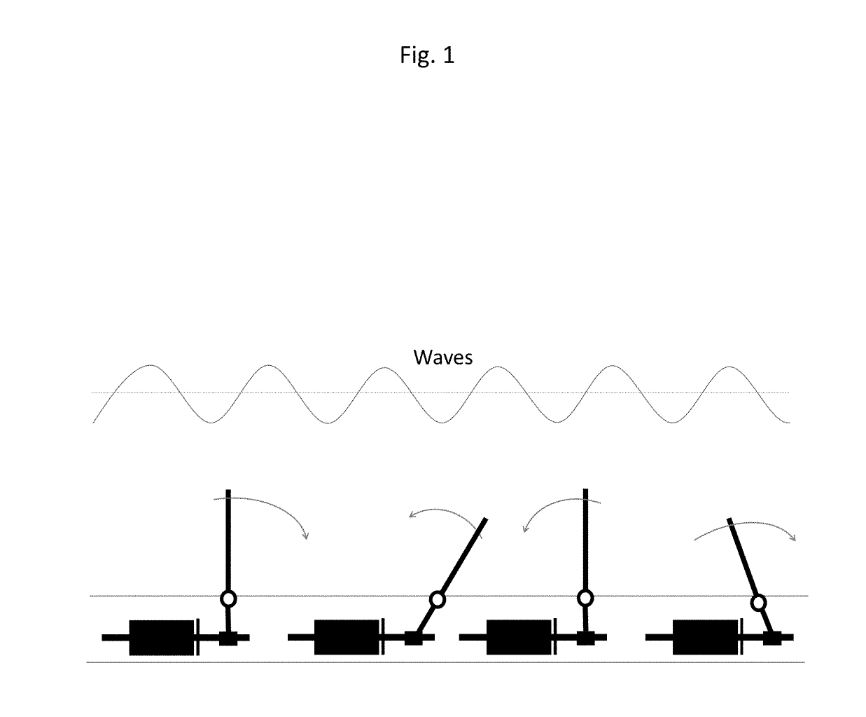

FIG. 2 illustrates a WEC based desalination system through use of an electric generator, battery and pump;

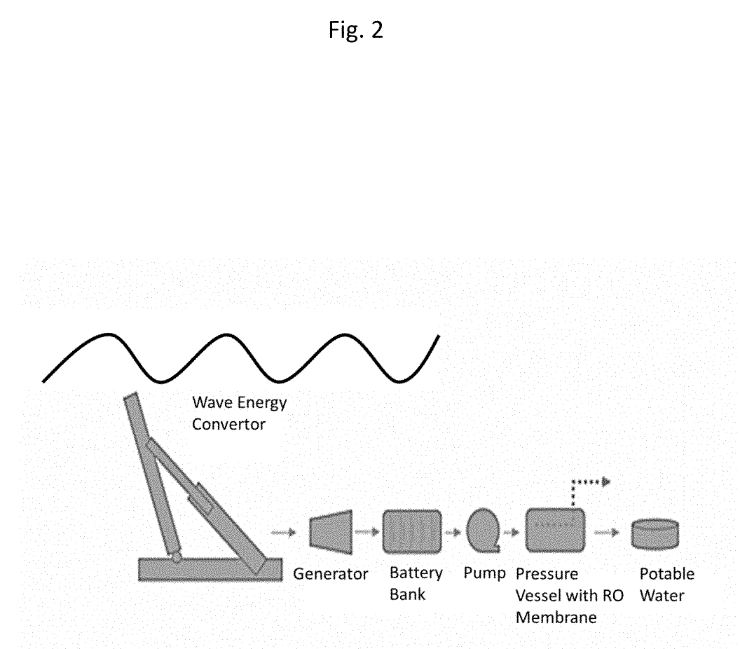

FIG. 3 illustrates the pressures on a WEC due to wave passage and a simplified depiction of a reverse osmosis desalination membrane;

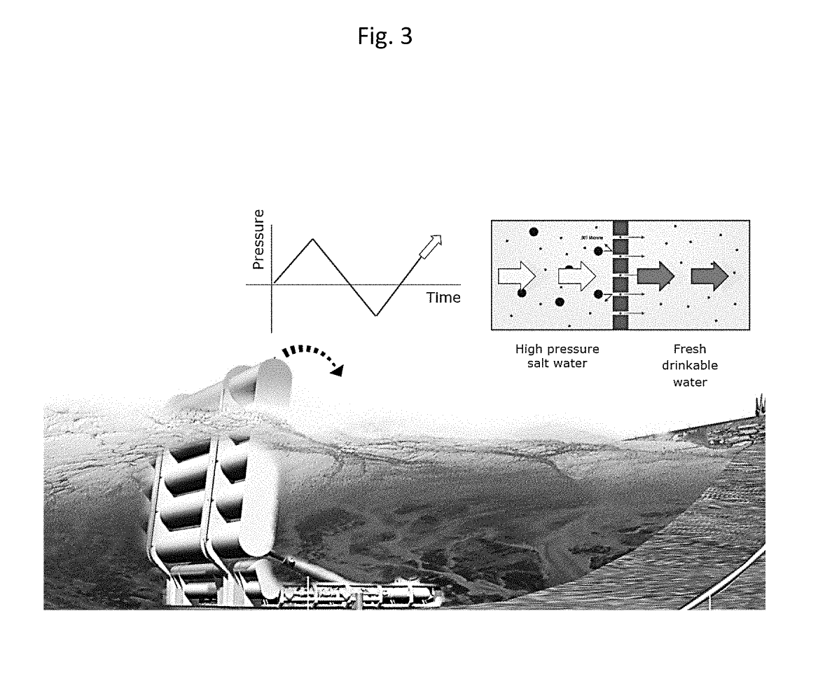

FIG. 4 illustrates a simplified single piston desalination system;

FIG. 5 illustrates a simplified dual piston desalination system;

FIG. 6 illustrates a single WEC piston and single spring driven piston desalination system;

FIG. 7 illustrates a physical embodiment of FIG. 4, with the cross shaped discharge nozzle used as a proxy for a reverse osmosis membrane;

FIG. 8 illustrates a computer rendering and a physical embodiment of FIG. 6, with the cross shaped discharge nozzle used as a proxy for a reverse osmosis membrane;

FIG. 9 illustrates a physical data from the second embodiment depicted in FIG. 8, with piston load force (N) on the y-axis and time (s) on the x-axis, with each plot depicting a different stiffness spring;

FIG. 10 illustrates a simplified rendering of the third physical embodiment;

FIG. 11 illustrates the fourth physical embodiment of the invention in operation on the test stand, producing desalinated water;

FIG. 12 illustrates physical data produced from the fourth physical embodiment showing pressure experienced by the reverse osmosis membrane while desalinated water is produced;

FIG. 13 illustrates physical test data from the fourth physical embodiment of the invention, with pressure experienced by reverse osmosis membrane modulated, while pressure experienced by the piston drops below 0 psi gauge before returning to high values;

FIG. 14 illustrates a summary of physical data produced from the fourth physical embodiment depicting several results with proving the efficacy of the invention;

FIG. 15 illustrates the use of a gearbox to disassociate the displacement of the piston from that of the WEC;

FIG. 16 illustrates a potential use of buoy based WEC to drive the piston;

FIG. 17 illustrates a plurality of buoys being used to increase the energy directed to the piston;

FIG. 18 illustrates a piston driven by air pressure variations inside of an enclosed chamber;

FIG. 19 illustrates a desalination system according to an embodiment of the invention, similar to the fourth physical embodiment depicted in FIG. 11;

FIG. 20 illustrates a desalination system pressurized by two separate pistons, each driven by a discrete WEC;

FIG. 21 illustrates the use of a plurality of springs used in series to provide a customized pressure modulation profile;

FIG. 22 illustrates the use of a plurality of springs used in parallel to provide a customized pressure modulation profile;

FIG. 23 illustrates a detail of an embodiment of the invention using springs both in series and in parallel to provide further customization of the modulation profile;

FIG. 24 illustrates the use of actuation devices to impede spring motion to control pressure profiles;

FIG. 25 illustrates an embodiment of the invention with a plurality of reverse osmosis desalination membranes;

FIG. 26 illustrates the use of a sensor for pressure, salinity, or other conditions controls the performance of the spring systems.

### DETAILED DESCRIPTION OF ILLUSTRATIVE EMBODIMENTS

Given that electrical systems do not provide an optimal utilization of the energy profile from WECs, this disclosure provides a novel system that embraces the periodic nature of a WEC, and mechanically couples it with a small reverse osmosis membrane to generate freshwater. To do this, one may integrate a piston or series of pistons, driven by the OSWEC, and a Reverse Osmosis pressure vessel.

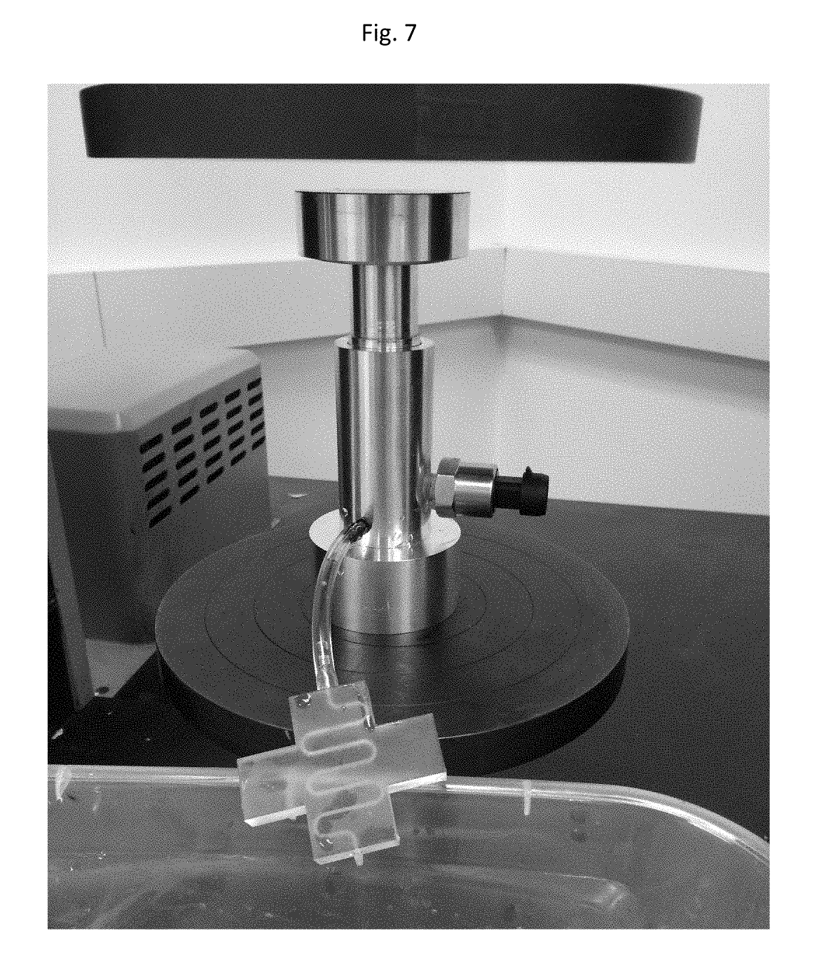

Single vs. Multiple Piston Systems: The simplest mechanical systems use a piston to pressurize and drive water past an RO membrane. The chamber with the membrane may be sealed using a check valve while the piston retracts, as in FIG. 7. The high pressure generated in the chamber will cause a percentage of seawater to pass through the RO membrane; the problem is that the pressure within the chamber will immediately begin to decline due to mass flow out if the vessel volume remains constant.

Single Piston: Due to the incompressibility of water, the loss of even a miniscule amount of water will cause a massive drop in pressure. Thus, the first tenet requires that either additional seawater be constantly supplied, or the volume constantly change. This makes a single chamber, single piston system an unviable solution.

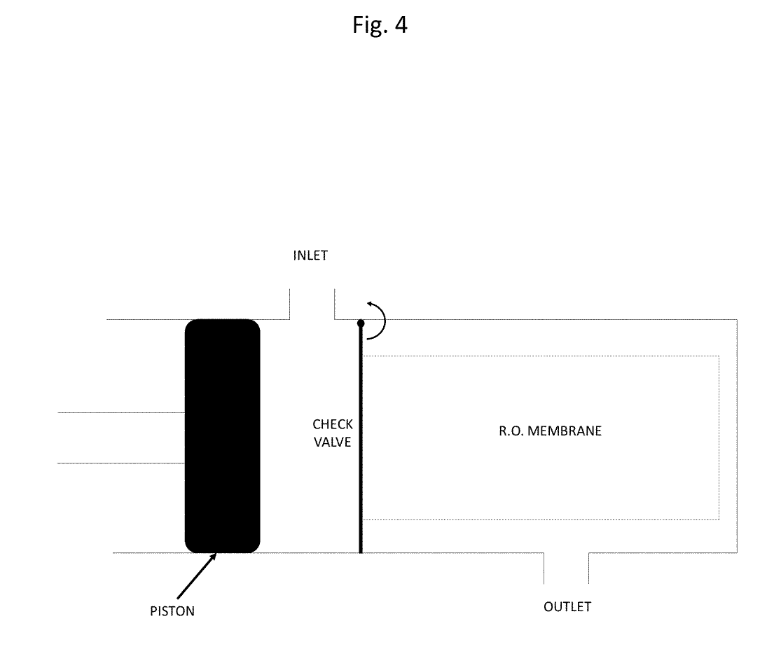

### FIG. 4—Hypothetical Single Piston System

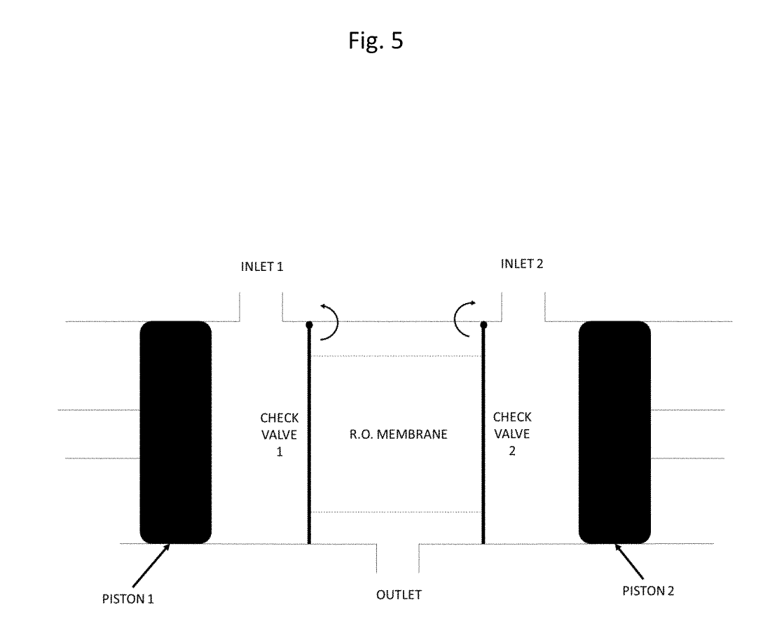

Multiple Driving Piston: The use of a multi stroke system, with multiple WECs and therefore multiple pistons and check valves working in tandem may solve the issue (see FIG. 5). However, if one assumes the force curves are perfect sine waves, superimposing them will still give two points with substantially lower force. Another embodiment may be to integrate three or four WECs in harmony, like a 3 stroke or 4 stroke engine. The increased mechanical complexity, small power generated by each WEC and distance between each unit make this infeasible.

### FIG. 5—Hypothetical Dual-Piston System

Pressure Exchanger Intensifier: Another option is a ‘Pressure-Exchanger Intensifier’, or Clark Pump. This system uses a pair of pistons, driving in opposite directions, with a single rod connecting them. This enables a low pressure pump source (either a WEC, or conventional pump) to drive each piston chamber sequentially, causing modulated, single direction flow. Some systems are designed to utilize the latent energy of the brine outflow from the Reverse Osmosis membrane as a power source, known as ‘Power Take Off’ (PTO).

Variable Volume Systems: If manipulating the timing of each piston is not sufficient to maintain a consistent, high pressure, one must use some form of energy storage. While liquids are not ideal gasses by any means, the physical basis of the ideal gas law (PV=mRT) can give insight. This suggests that a system can maintain a constant pressure with decreasing mass by either altering the volume or the temperature. Heating a flowing liquid underwater via a purely mechanical system is extremely challenging, and would cause substantial issues due to thermal expansion of components. Therefore most devices must vary the volume of the system.

Bladder Tanks: A bladder pressure tank contains pressurized air and water separated by a flexible membrane (bladder). These tanks are typically precharged with air at the factory. As water pressure changes, the volume of air in a bladder tank contracts and expands. One may consider the use of this technology as a means of energy storage to maintain or rectify pressure consistently. Typically underwater air bladders are rated for pressures of up to 50 psi. While an attractive option, this pressure would be insufficient to efficiently execute reverse osmosis desalination, a process that requires at least twice the capability of an air bladder. Flow rates are linked proportionally to the driving pressure meaning that, generally higher pressures yields greater outflow rates of potable water.

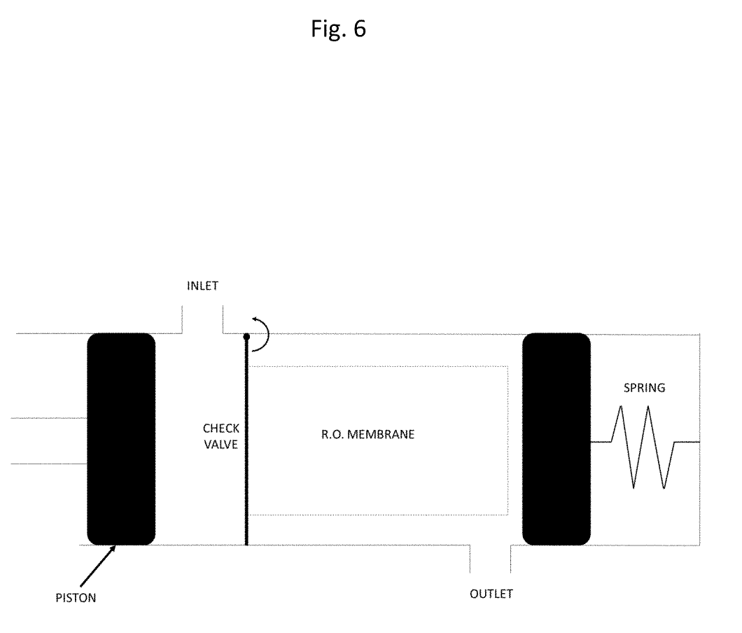

Spring-Based Energy Storage System: Another type of system is a spring-based energy storage system. On the forward stroke of a wave, the saltwater is compressed and pressurized as in any other case, but additionally, the spring (which may be attached to a sealed piston) compresses and stores energy. Then, on the backstroke of the wave, the spring slowly returns to its initial position, releasing the energy that it stored on the forward stroke. This accomplishes the change in volume that is necessary to keep the pressure high on the water inside the system, thereby avoiding the rapid pressure fluctuations created by ocean waves. Additionally, this type of system is resistant to wear over time and makes maintenance much simpler than a bladder tank would, for example. A schematic of such a system appears in FIG. 6.

### FIG. 6—Hypothetical Spring-Based Energy Storage System

Multiple Spring Systems: One may also consider the possibility of using several springs either in series or in parallel to achieve the perfectly ideal spring constant, or to create a non-linear pressure recovery curve. Tuning a system by installing multiple springs both in series and parallel would lead to far more efficient devices.

### Exemplary Embodiments

The first iteration pressure vessel can be seen in FIG. 7. It consisted of a simple single spring system, similar to the initial components of FIG. 4. On the right of the image, a tapped hole and adaptor for a pressure transducer can be seen. The clear tube leads to a pressure reduction device, using a microfluidic tube to cause large pressure losses, before releasing the liquid to a bucket. The piston was of relatively standard design, with grooves for two O-rings included.

### FIG. 7—Photograph of First Embodiment

The second prototype was tested with an MTS (Tension-Compression system). The MTS drove a large flat plate downwards, at a chosen, fixed displacement rate and allowed for observation of the pressure fluctuations inside the pressure vessel. The MTS was not used as a tension system on the second prototype, as there was no water inlet yet installed. This meant there was no physical attachment between the MTS Crosshead and the piston—they lay flat against each other in simple compression.

The tests performed on the second prototype allowed for understanding the effects of spring stiffness on the pressure decay inside the system. For a given displacement rate, diameter and outflow resistance, there must be an optimal stiffness spring. One may purchase a series of springs of different stiffnesses and test them in the prototype setup to observe empirically how the stiffness of a spring affected the performance of the system. Four springs were tested with stiffnesses of: 17 N/mm, 40 N/mm, 70 N/mm, and 150 N/mm.

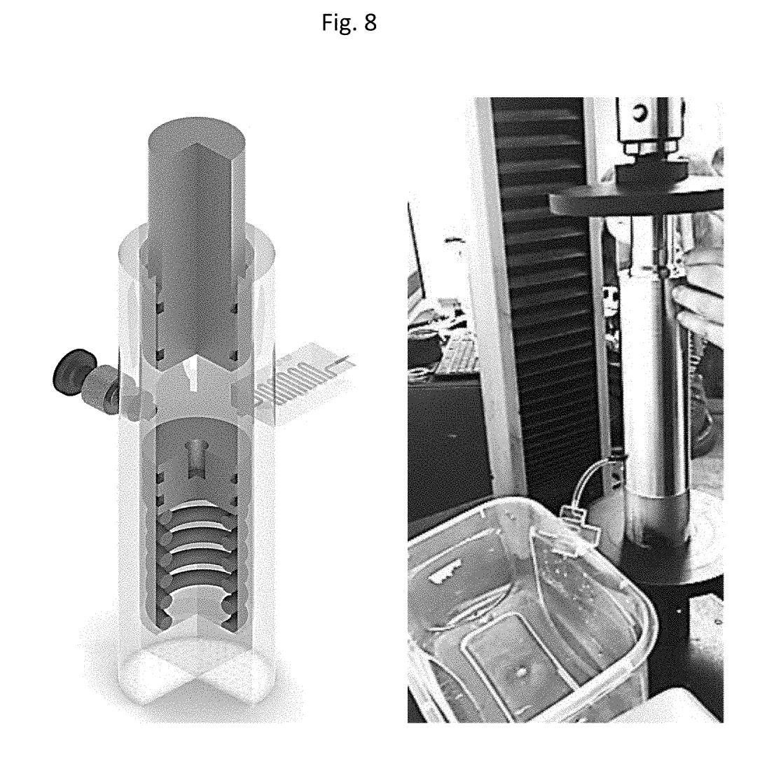

### FIG. 8—Rendering and Photograph of Second Embodiment

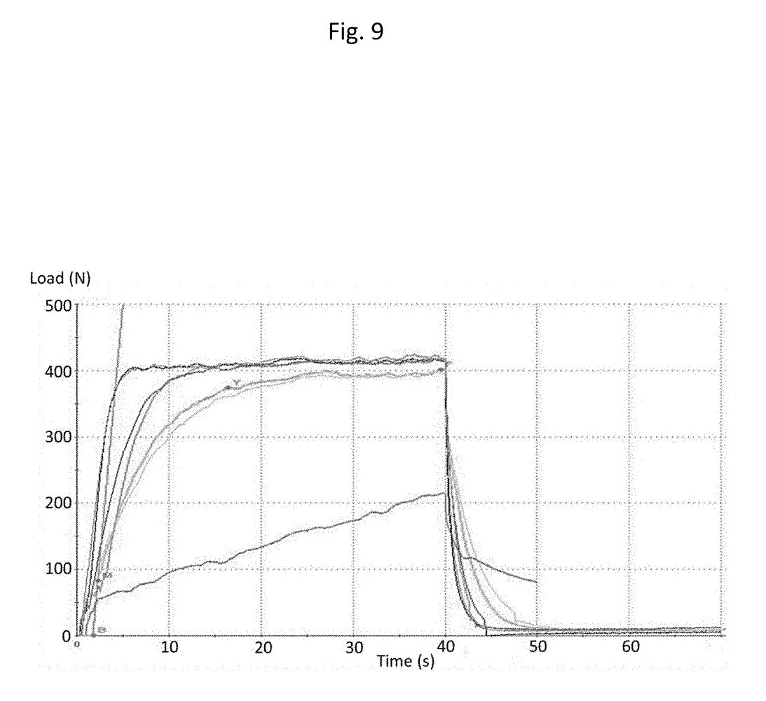

Tests were performed with each of these springs. Without any spring, the pressure decay would look like a square wave with close to 90° angles between the vertical and horizontal sections (depicted by the uppermost line in FIG. 9). The weakest spring, (shown by the diagonal line in FIG. 9) was not always optimal, while the stiffest spring, generally follows the square wave, albeit with a slower ramp up and some limited energy storage at the end. A medium stiffness spring, has a more gradual, curved ramp in pressure, and does store a substantial portion of energy (defined as the area under a Force-Time plot, when displacement is fixed at a constant rate). This indicated that there were springs that were both too stiff and too pliant for the system, and one may optimize to find a middle ground. One may model these pressures and decays using mathematical software, e.g., MATLAB.

### FIG. 9—Pressure Decay Curves for Springs of Various Stiffnesses

Move to Modular System Design: The final embodiment was modular, due to a number of benefits. For example, if a single component of the system malfunctions, it can simply be removed and replaced. In addition, using commercially available NPT threaded connections, off the shelf valves could be easily integrated, tested and serviced.

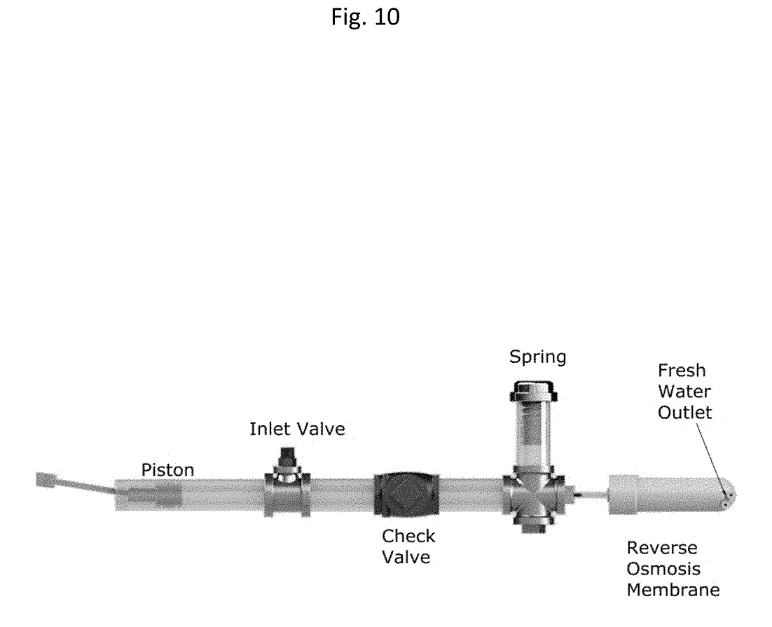

FIG. 10 provides a further view of an illustrative system (the third embodiment). An exemplary system contained three main sections: an inlet chamber, a spring and reverse osmosis chamber, and a check valve separating the two. A system may be designed to allow the integration of WECs with RO desalination by utilizing a spring and a series of valves. These components are able to modulate pressure inside a chamber containing a reverse osmosis membrane such that the outflow of clean water remains nearly constant, and the damage to the membrane is minimized. A reverse osmosis system has been installed to produce desalinated water, while an inlet valve allows a brine mixture to refill the test system for continuous operation.

### FIG. 10—Rendering of an Illustrative System (Third Embodiment)

Piston: On the forward stroke of an ocean wave, a WEC drives the inlet piston forward. On the back stroke of the wave, as the WEC returns to its natural position due to buoyancy, that piston simply retracts out of the chamber. The pistons used were machined out of aluminum, and had industry standard nitrile o-rings installed inside of grooves to provide liquid sealing under pressure. Packing or mechanical seals could be used in future iterations, as well as other pressure isolation systems.

Inlet and Check Valve: During this retraction phase, the inlet valve opens and lets new seawater into the system. The check valve, in the center of the device, is open on the forward stroke of the wave. On the back stroke of the wave it closes, effectively isolating the inlet chamber from the reverse osmosis chamber. A ball valve was used for the inlet due to the small sizes available off the shelf, and a larger swing check valve was used to separate the chambers.

Spring: On the forward stroke of the wave, the spring compresses and is able to store energy. This energy storage phase is defined as Phase I of system operation. On the back stroke of the wave, when the check valve is closed, the spring is slowly returning to its extended position, thereby releasing the energy that it stored on the forward stroke of the wave. This is defined as Phase II of system operation. This slow release of energy keeps high pressure on the reverse osmosis membrane. The membrane therefore does not experience the rapid pressure fluctuations that would subject it to damage, and it is constantly producing fresh, drinkable water.

Check Valves: The invention seeks to separate the pressures on the reverse osmosis section of the device from the driven side, isolated by a check valve. One wishes to avoid the backflow of fresh water because it would both increase the rate of membrane degradation and reduce output. A number of different options can be used—both ball and swing valves were utilized in the embodiment.

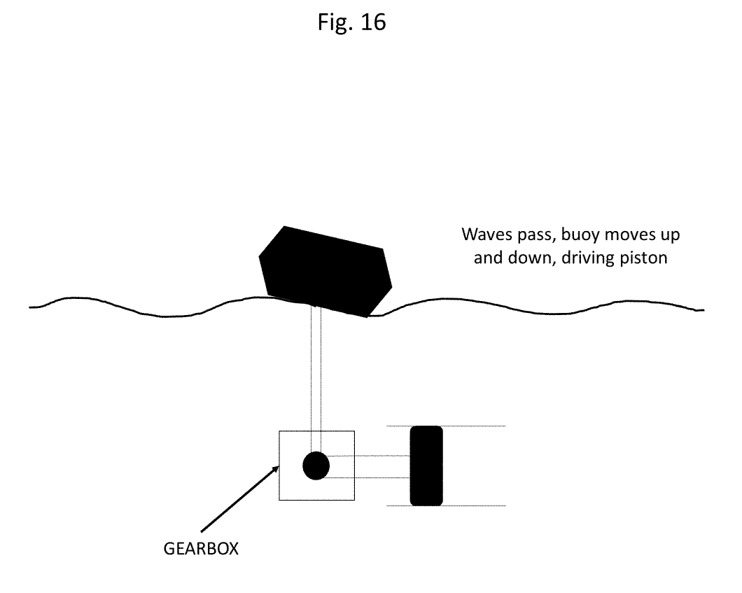

Fourth Embodiment: The fourth (and final physical) embodiment added an elbow joint to allow more efficient testing and higher flow rates of potable water. However, due constant fluid communication, orientation has no impact on system performance due to low fluid head differences in pressure. FIG. 16 shows the full system with both a brine source (red cooler, center background), potable water collection pot (clear beaker, left foreground) and brine disposal (black bucket, right). The MTS driver is shown in the left of the frame.

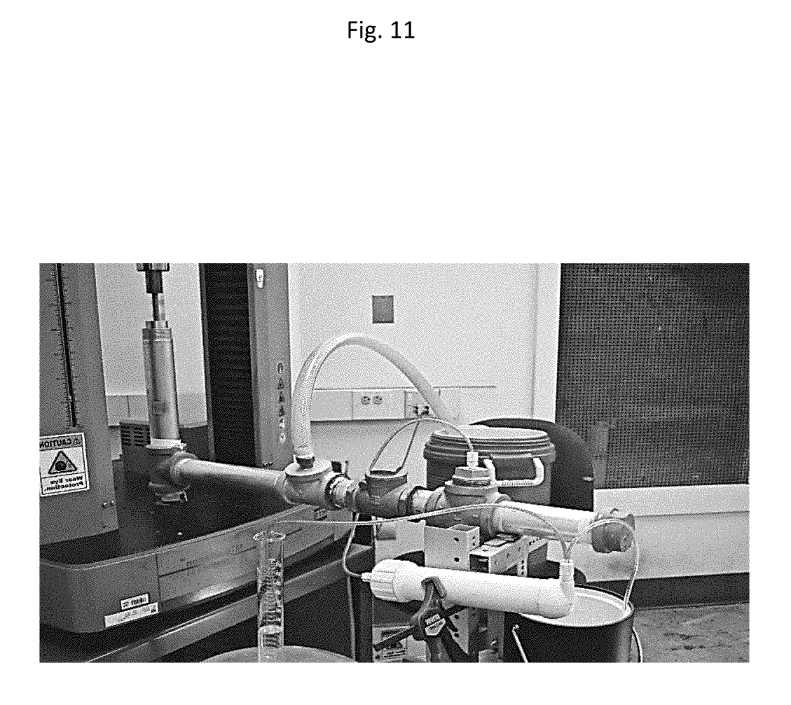

### FIG. 11—Photograph of Fourth Embodiment in Testing Setup

The MTS driver was modified to drive the piston both up and down to simulate the motion that it would undergo if it were operating in an ocean. The crosshead was run at various speeds for a set of predetermined time periods. These speeds and periods were meant to simulate common, real-life ocean wave conditions.

The periods of time for which the tests were run mimicked ocean wave periods in real life. Ocean wave periods vary from about 8 seconds long up to around 25 seconds long. For this reason, exemplary embodiments underwent testing at simulated wave periods of 6, 8, 10, 12, 14, and 20 seconds.

Crosshead speeds were chosen based on the limits of the experimental setup. If the crosshead ran too slowly, it was unable to close the isolation check valve in the center of the system. Alternatively, at very fast crosshead speeds, sometimes the pressure inside the system became high enough that water could leak behind the spring piston. This would cause the pressure inside the system to build at a rapid pace. Devices were tested at crosshead speeds between 1 and 7 mm/s, in 0.5 mm/s intervals.

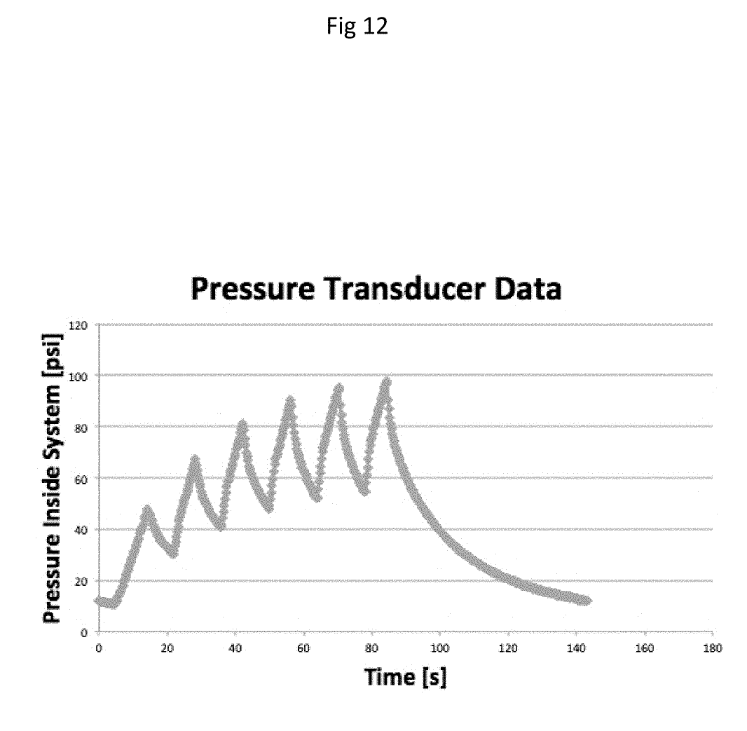

For every combination of “wave period” and “wave speed,” the system underwent six simulated wave cycles. This accounted for a settling period, to allow the pressure profile to steady. An example of such a trend is shown in FIG. 12. This particular pressure data arose when the spring inside the system had a stiffness of 40 N/mm and the crosshead speed was 4 mm/s. This data was collected for approximately 200 different test regimes.

### FIG. 12—Data Collected From One Test Regime

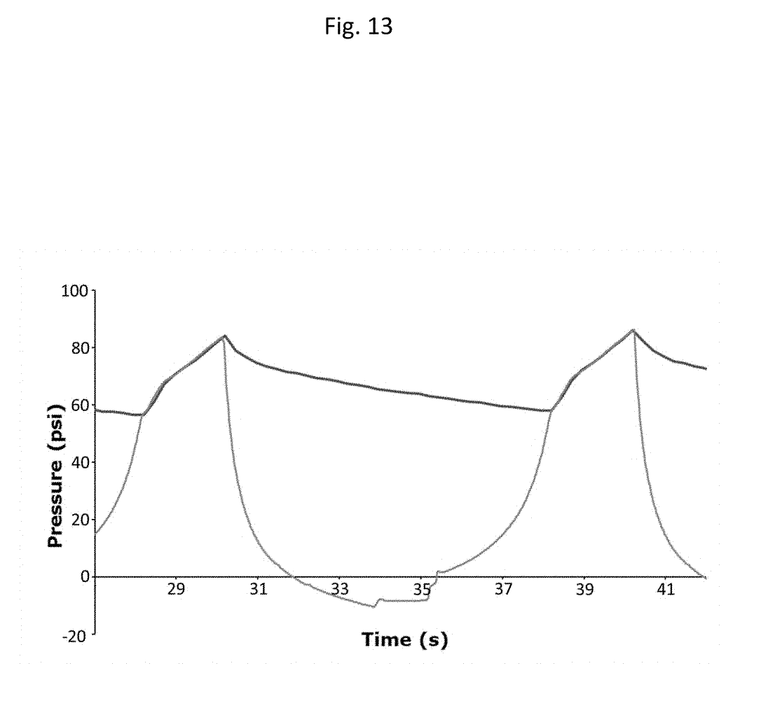

From graphs like the one in FIG. 12, one is able to understand how pressure fluctuates inside the system. For example, the data shows a pressure fluctuation of 21.63 psi about an average pressure of 76.30 psi, meaning that the pressure was fluctuating by 28.3% under this particular set of conditions. However, to understand the significance of this, it is important to note the difference between the force/pressure readings at the crosshead (which are equivalent to those in the inlet of the system) versus those at the pressure chamber and reverse osmosis chamber. To do this, one may create plots such as the one shown in FIG. 13.

### FIG. 13—Graph Showing Modulation of Pressure

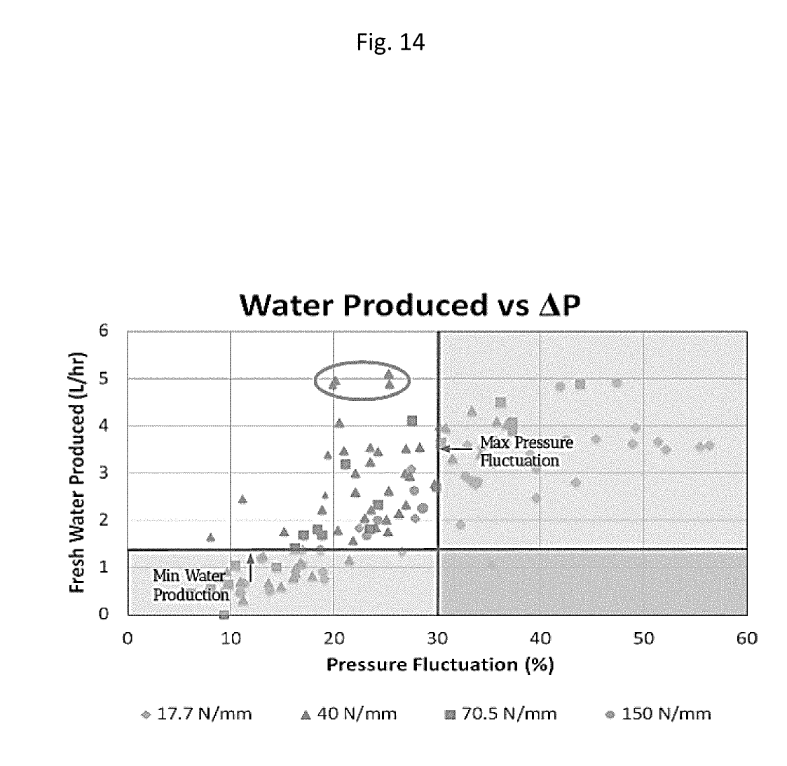

This figure shows, conceptually, the pressure profile that the system would see without the disclosed technology (the paler line that dips below the x axis) versus the pressure profile created by the disclosed technology (upper, darker line). This plot is proof that the system is working; it is alleviating the hypothetical rapidly fluctuating pressure profile to something much closer to constant pressure. Testing a range of both wave frequencies, piston displacements and spring stiffnesses creates a plot of the two key metrics: pressure fluctuation at the membrane surface and the volume of potable water produced (FIG. 14).

### FIG. 14—Water Produced Versus Pressure Fluctuation for All Tests

From this graph, one may impose several constraints regarding data points that are relevant. Firstly, any pressure fluctuation over the 30% mark may be potentially unsafe for reverse osmosis membranes. In addition, there is a minimum output flow rate that the system must produce in order to provide enough water for a family. This minimum amount of water is 1.25 L/hr. Finally, the ideal operation of the system is the point at which it produces the most water and experiences the minimum pressure fluctuation. Taking each of these points into consideration, one can identify the optimum operating point, shown on the following graph inside the oval. This means that the spring that works best for the exemplary system is that of stiffness 40 N/mm. Using this spring, and at particular operating conditions, the exemplary system was able to produce five liters of clean drinking water per hour while experiencing a pressure fluctuation as low as 25%.

Such a value is the solution for the testing of the fourth embodiment, but any other scenarios can also be solved for, based on the exact WEC specifications, RO membrane chosen and waves expected.

To predict such conditions, a number of modeling techniques can be used. For waves, there is a substantial body of literature on predicting and defining wave shapes and forces. Internal to the device, there are many different fluid dynamic theories that can be applied to modeling. Understanding the pressure decay inside the system when the check valve is closed and the RO membrane is in contact with the spring-piston system is possible with empirical data. To validate these results, one may pressurize the system to a variety of peak pressures and observe how the pressure decayed when the piston was held in a constant position. The four laws that were used for comparison were the Darcy-Weisbach equation, the Hagen—Poiseuille law, flow through an orifice, and fluid flow through porous media.

One can use comparisons between the pressure readings from the first, second and third embodiments with the above laws to develop a MATLAB simulation that models the system's dynamics.

### Potential Variations of Desalination Device

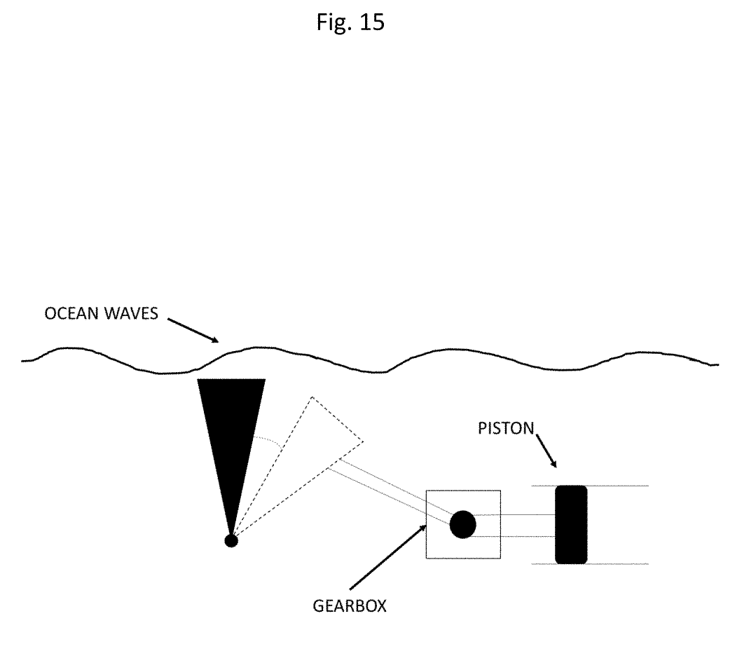

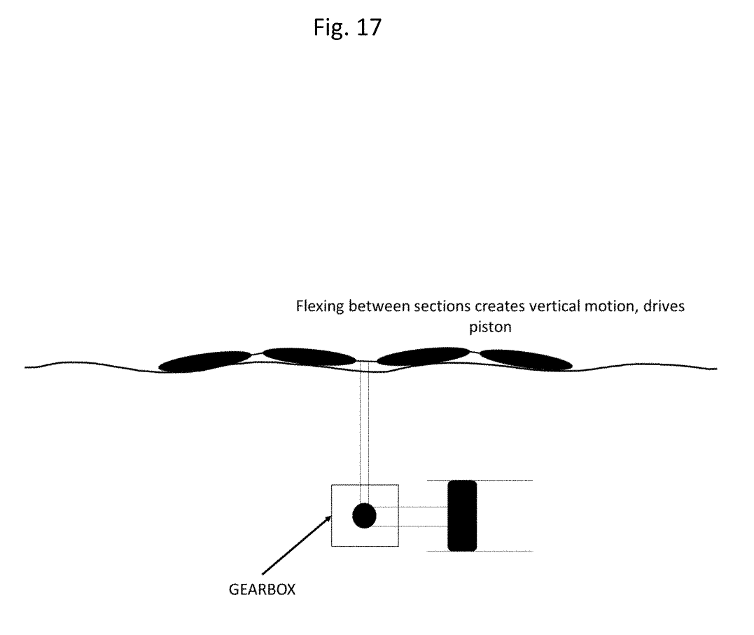

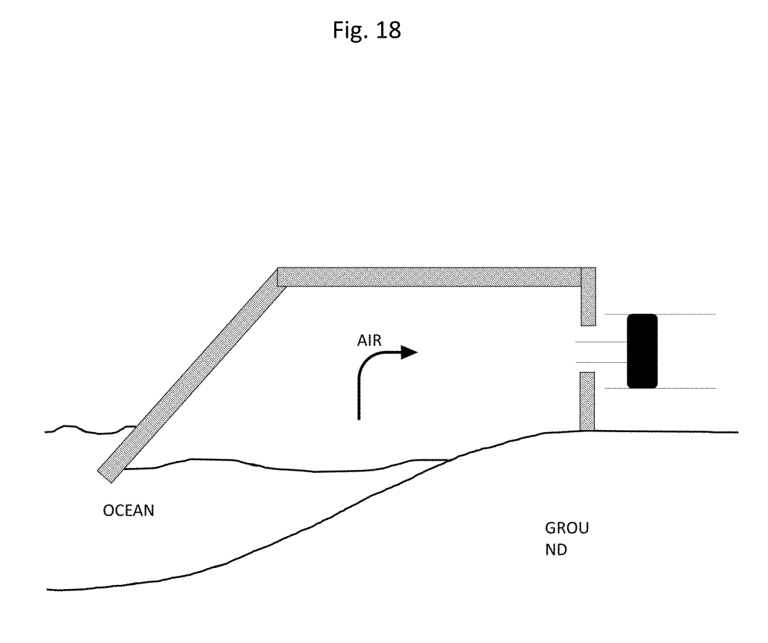

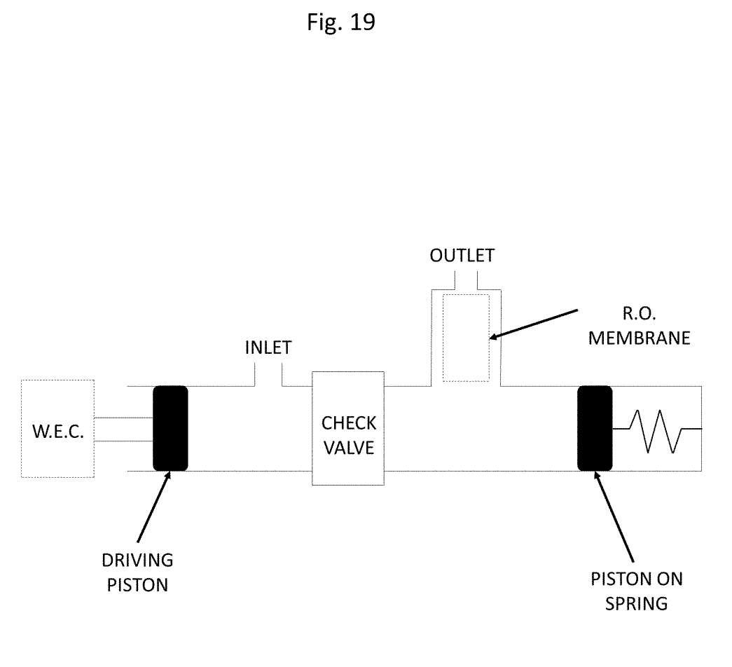

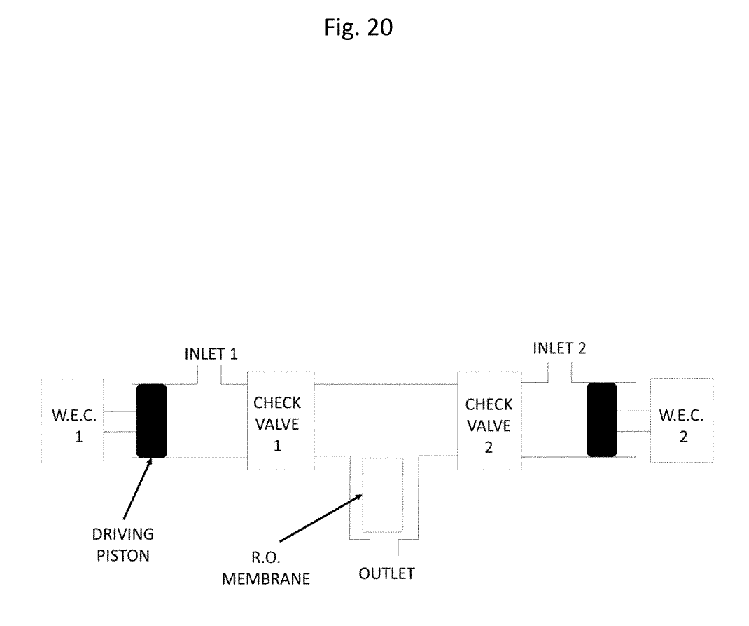

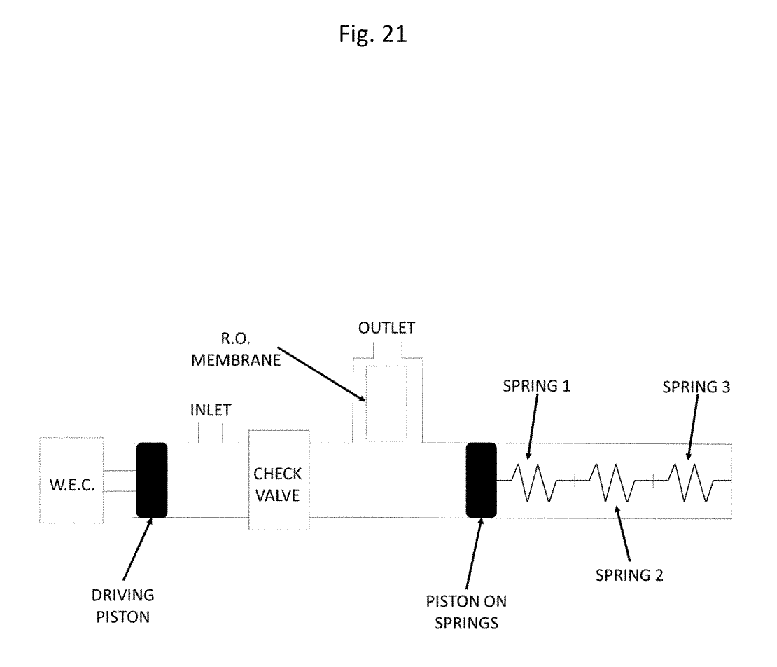

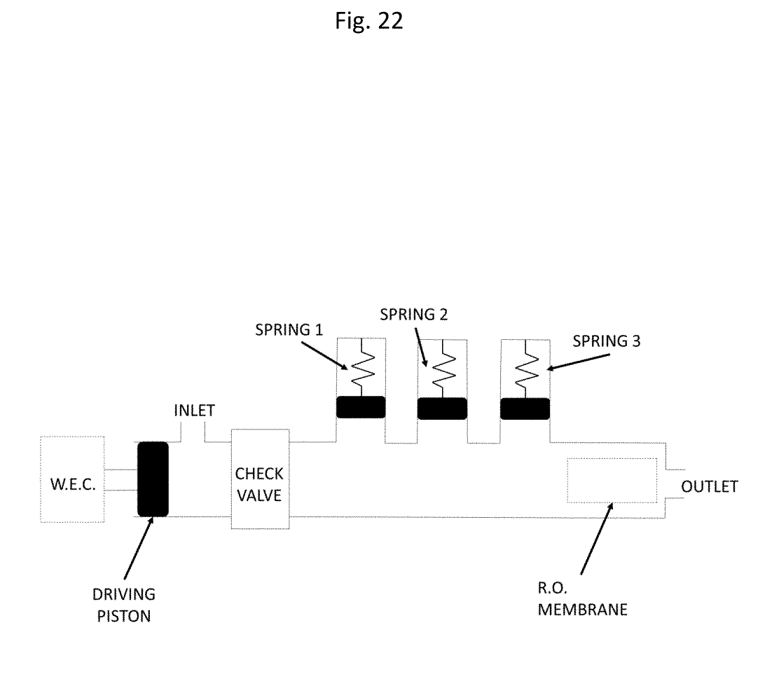

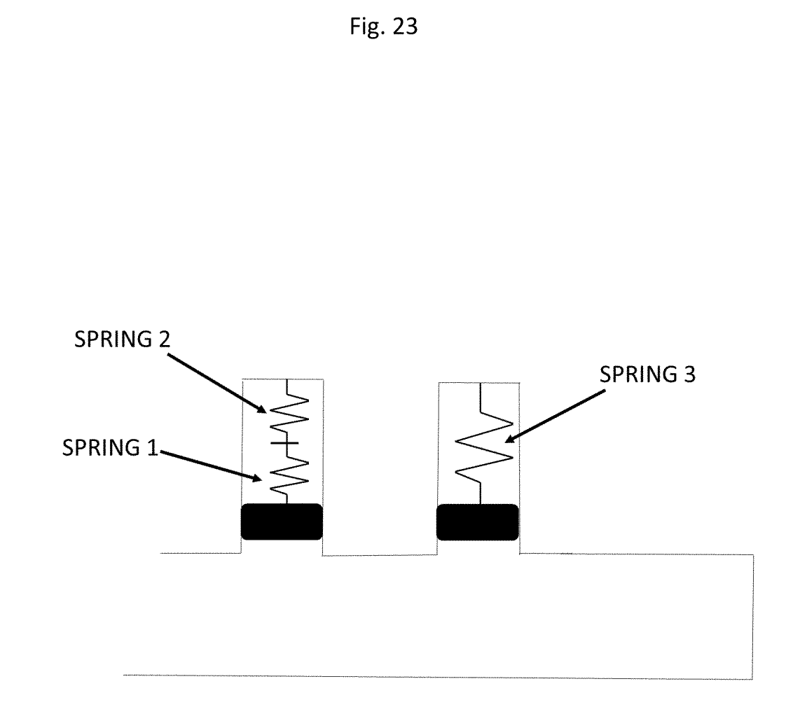

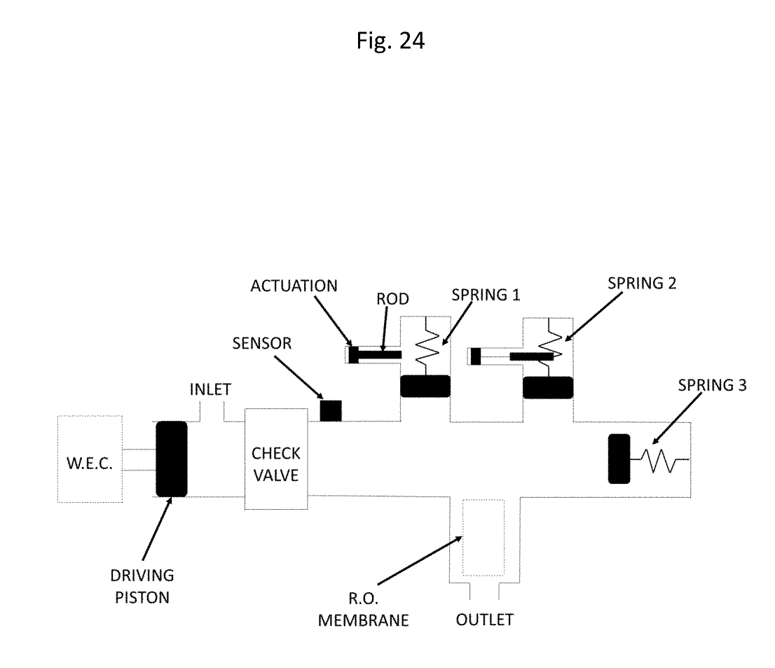

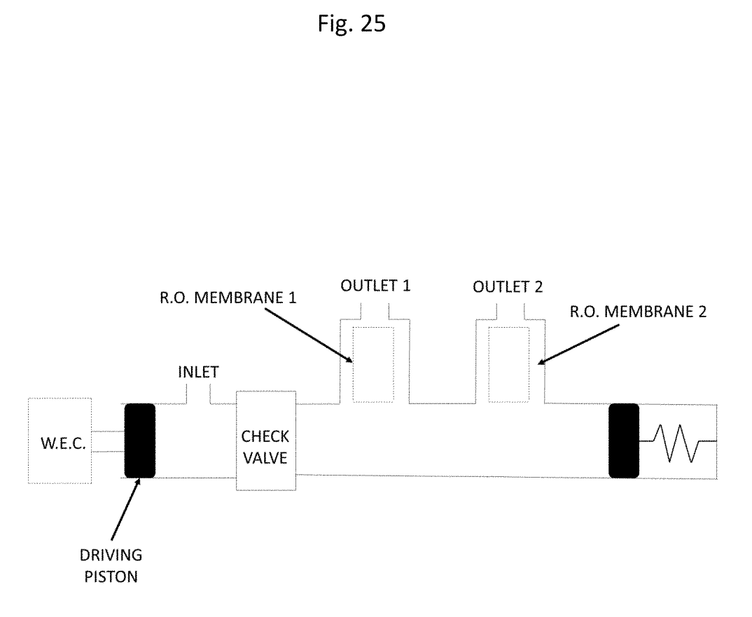

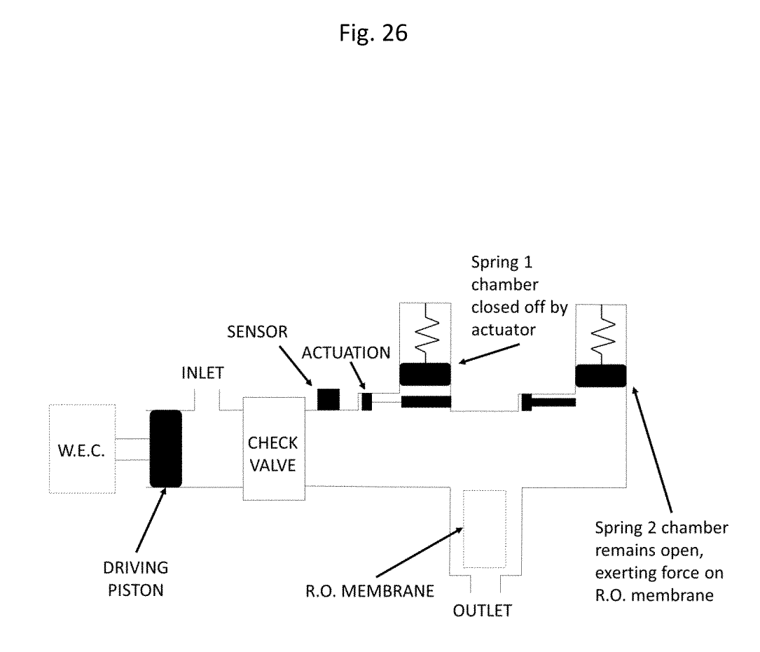

### FIGS. 15-26—Hypothetical Implementation of Exemplary Systems on a WEC

FIGS. 15-26 disclose alternative embodiments of the desalination device. In some embodiments, the desalination device may include a gearbox. The gearbox can regulate the velocity, rate, or force of the piston, as well as other features of the device.

The desalination device may include a buoy configured to flow on water, the buoy being operatively connected to the piston. In some embodiments, a plurality of buoys or lighter-than-water floatation structures may be connected to the piston.

In some embodiments, the piston may be driven by air pressure. Air may enter an air receptacle having an interior, the interior being in fluid communication with the piston. Air may actuate the piston in one or more directions.

In some embodiments, the piston may be connected to a spring member, the spring member being configured to compress when contents of the compression chamber are moved toward the reverse osmosis membrane.

The desalination device may include a plurality of wings and a plurality of pistons configured to operate within one compression chamber and move contents of the compression chamber towards one reverse osmosis membrane.

In some embodiments, the desalination device may include a plurality of springs. The springs may be connected in series relative to one another. Alternatively, the springs may be connected in a parallel arrangement to one another. In a further embodiment, a desalination device may include springs that are connected in series and springs that are connected in parallel.

The desalination device may include a plurality of reverse osmosis membranes. The reverse osmosis membranes may have varying properties. In some embodiments, an actuator may isolate, open, or close one or more reverse osmosis membranes.

Spring members may include non-linear spring members configured to compress in a non-linear manner, such that force exerted on the piston by the spring member varies as a function of the state of the system.

In some embodiments, spring member stiffness may be controlled by an actuator connected to the desalination device. The actuator may isolate or disengage one or more springs. The actuator may operate in response to a command provided by a pressure sensor.

In further embodiments, the desalination device may include an electronic controller. The controller may receive data from a sensor attached to the device, either through a wire or wirelessly. The controller may be configured to provide an electrical current to a spring member such that the stiffness increases or decreases.

What is claimed:

1. A desalinating device, comprising:
a compression chamber having an interior and being configured to receive water,
the compression chamber having an inlet, a proximal end, a distal end, and a major axis extending longitudinally from the proximal end to the distal end;
an inlet one-way valve sealably engaged with the inlet,
the inlet one-way valve being configured to permit flow into the compression chamber from exterior to the compression chamber;
a piston operatively coupled to a wing,
the piston being sealably disposed within the compression chamber, and,
the piston being configured to move along the major axis of the compression chamber in the direction of the distal end of the chamber in response to the movement of the wing;
a reverse osmosis membrane being in fluid communication with the interior of the compression chamber such that motion of the piston in the direction of the distal end of the compression chamber exerts contents of the interior of the compression chamber against the reverse osmosis membrane; and
a spring member in fluid communication with the interior of the compression chamber,
the spring member being configured to compress when the piston moves in the direction of the distal end of the compression chamber.

2. The water desalinating device of claim 1, further comprising a check valve disposed within the compression chamber, the check valve being disposed between a first portion of the compression chamber and a second portion of the compression chamber,
the check valve being disposed between the piston and the spring member, and
the check valve being configured to permit flow in the direction of the spring member and resist flow away from the spring member.

3. The water desalinating device of claim 2, wherein the spring member, when decompressing and when the check valve is closed, is configured to exert contents of the compression chamber against the reverse osmosis membrane.

4. The water desalination device of any of claims 1-3, wherein the inlet one-way valve is configured to allow the water to pass in one direction through the valve into the compression chamber when the pressure inside the compression chamber is lower than the pressure outside the compression chamber, and to prevent the water from passing in the opposite direction through the valve out of the compression chamber.

5. The water desalination device of any of claims 1-4, wherein the spring member has a spring stiffness in the range from 10 N/mm to 500 N/mm, or a non-linear spring stiffness.

6. The water desalination device of any of claims 1-5, further comprising a controller positioned between the wing and the piston, the controller having an adjustable gear set configured to regulate the velocity and displacement of piston movement.

7. The water desalination device of any of claims 1-6, wherein the wing includes a lighter-than-water buoy portion attached to the wing.

8. The water desalination device of any of claims 1-7, wherein the driver includes an air receiving portion that is configured to receive air caused by motion of the water source and to use the received air to propel the piston.

9. The water desalination device of any of claims 1-8, wherein the spring member is positioned between the proximal end and the distal end of the compression chamber.

10. The water desalination device of any of claims 1-9, wherein the reverse osmosis membrane is positioned between the proximal end and the distal end of the compression chamber.

11. The water desalination device of any of claims 1-10, further comprising a plurality of wings and compression chambers, wherein the plurality of wings and compression chambers are in fluid communication with the same reverse osmosis membrane.

12. The water desalination device of any of claims 1-11, wherein the spring member includes a plurality of springs, some of which may be positioned in series relative to one another and some may be positioned in parallel relative to one another.

13. The water desalination device of any of claims 1-12 wherein the spring member includes a spring actuator configured to engage and disengage the spring member in response to a command.

14. The water desalination device of claim 13, wherein the command comes from a sensor connected to the device through wires or wirelessly.

15. The water desalination device of any claims 1-14, where a damping member is positioned in parallel, in series with, or instead of any of the spring members.

16. The water desalination device of any of claims 1-15, further comprising a plurality of reverse osmosis membranes, wherein the plurality of reverse osmosis membranes is in fluid communication with the same compression chamber, some of which may be isolated by an actuator.

17. The water desalination device of any of claims 1-16, the water desalination device being configured to, during operation, permit pressure fluctuation on the reverse osmosis membrane of up to 60%, up to 50%, up to 40% up to 30% or up to 20%.

18. The water desalination device of any of claims 1-17, further comprising a spring chamber having an interior that is in fluid communication with the interior of the compression chamber, wherein at least a portion of the spring member is disposed within the spring chamber.

19. The water desalination device of any of claims 1-18 wherein the piston includes a set of a first piston and a second piston, each of the first and second pistons being operatively connected to the wing such that movement of the wing in a first direction causes the first piston to move along the major axis toward the reverse osmosis membrane, and where movement of the wing in a second direction opposite the first direction causes the second piston to move along the major axis toward the reverse osmosis membrane.

20. The water desalination device of any of claims 1-19, wherein the driving force is any form of Wave Energy Convertor, or any other form of mechanical driver.
